(19) United States
(12) Patent Application Publication
(10) Pub. No.: US 2013/0331148 A1
(43) Pub. Date: Dec. 12, 2013

(54) Image Modifying Assembly for Smart Devices

(71) Applicant: Richard Brough, Henderson, NV (US)

(72) Inventor: Richard Brough, Henderson, NV (US)

(21) Appl. No.: 13/494,947

(22) Filed: Jun. 12, 2012

(51) Int. Cl. H04W 88/02

(52) U.S. Cl. 455/557

(57) ABSTRACT

An image modifying assembly for connection to a smart device, such as a smartphone or smartpad, is disclosed. The assembly includes an adapter case for receiving the smart device, a connector attached to the adapter case, a locking collar operably associated with the connector for removable attachment thereto, and a clamping device having a first clamping portion for connection to the locking collar, a second clamping portion spaced from the first clamping portion, and a bore extending between the first and second clamping portions. The bore together with the locking collar and opening provide an optical path for the camera associated with the smart device. The second clamping portion is adapted for connection to an image modifying device, such as a spotting scope, lens, night vision monocular, and so on, to thereby modify an image before it is received by the camera.

### BACKGROUND OF THE INVENTION

This invention relates to optical devices, and more particularly to an assembly and kit for adapting smart devices, such as smartphones or smartpads, to accept optical viewing components such as scopes, lenses, night vision devices, and so on, for viewing, recording and/or transmitting images as modified by such components.

Smart devices, such as smartphones, smartpads, and the like, typically have a built-in digital camera system with a two-dimensional optical sensor array, a lens, processing circuitry and software to display and record still and moving images. Although such sensor arrays typically have high resolution, the lens associated with the sensor array can be somewhat lacking. Accordingly, many smart devices capture high resolution images that are simply not appealing or of little use to the user or person viewing the images. Although digital cameras with motorized lenses or exchangeable lens systems allow the user to obtain desired image effects, smart devices simply lack the capacity in and of themselves to provide the user any options, besides digital zoom, to modify the image before it is captured.

In an effort to overcome the shortcomings of smartphones, a telephoto lens has been specifically developed for removable connection to one type of smartphone, commonly known as the iPhone™. Although such a device may work for its intended purpose, the telephoto lens can only be used for the iPhone™. Where a user already has a telephoto lens, wide angle lens, and other image modifying devices, as well as other types of smart devices, the requirement to purchase a redundant image modifying device for a particular application can be frustrating. Still, the telephoto lens provides increased image modifying capacity of the smartphone to a very limited extent.

It would therefore be desirous to provide a universal system for adapting any image modifying device to any smart device without the necessity of purchasing redundant equipment specifically intended for only one application. In law enforcement and military applications where image modifying devices, such as lenses, rifle or gun scopes, spotting scopes, night vision monoculars, and so on, may have already been purchased, it would be advantageous to connect these devices to a smartphone or the like, thereby enabling live streaming to a monitoring location of mission critical events as they unfold. There is a further need in the art for an optical viewing assembly that can be modified in a relatively quick and easy manner to accommodate a wide variety of needs of different users in varying image viewing, recording and/or transmitting situations.

### BRIEF SUMMARY OF THE INVENTION

In accordance with one aspect of the invention, an image modifying assembly for a smart device having an image capturing portion, includes an adapter case for receiving the smart device, a connector attached to the adapter case, a locking collar operably associated with the connector for removable attachment thereto, and a clamping device having a first clamping portion for connection to the locking collar, a second clamping portion spaced from the first clamping portion, and a bore extending between the first and second clamping portions. The bore together with the locking collar and opening providing an optical path for the image capturing portion. The second clamping portion is adapted for connection to an image modifying device to thereby modify an image before it is received by the image capturing portion.

In accordance with a further aspect of the invention, an image modifying kit for a smart device having an image capturing portion, includes an adapter case for receiving the smart device. The adaptor case has a rear wall with an opening for alignment with the image capturing portion and a connector located on the wall in alignment with the opening. A plurality of locking collars are operably associated with the connector for removable attachment thereto, with each locking collar being of a different size. A clamping device has a first clamping portion for connection to the locking collar, a second clamping portion spaced from the first clamping portion, and a bore extending between the first and second clamping portions. The bore together with the locking collar and opening provide an optical path for the image capturing portion. A plurality of resilient bushings are adapted to be received in the second clamping portion, with each bushing being of a different size for receiving different image modifying devices. The second clamping portion is adapted to clamp and hold a selected one of the resilient bushings with an image modifying device to thereby modify an image before it is received by the image capturing portion.

### BRIEF DESCRIPTION OF THE DRAWINGS

The foregoing summary as well as the following detailed description of the preferred embodiments of the present invention will be best understood when considered in conjunction with the accompanying drawings, wherein like designations denote like elements throughout the drawings, and wherein:

FIG. 1 is a front isometric view of an image modifying assembly for smart devices in accordance an exemplary embodiment of the invention;

FIG. 2 is rear isometric view thereof;

FIG. 3 is an exploded front isometric view of the image modifying assembly;

FIG. 4 is an exploded rear isometric view thereof;

FIG. 5 is a front elevational view of an adaptor case for a smart device;

FIG. 6 is a rear elevational view thereof; and

FIG. 7 is a front isometric view of an exemplary image modifying kit in accordance with the invention.

It is noted that the drawings are intended to depict only typical embodiments of the invention and therefore should not be considered as limiting the scope thereof. The invention will now be described in greater detail with reference to the accompanying drawings.

### DETAILED DESCRIPTION OF THE INVENTION

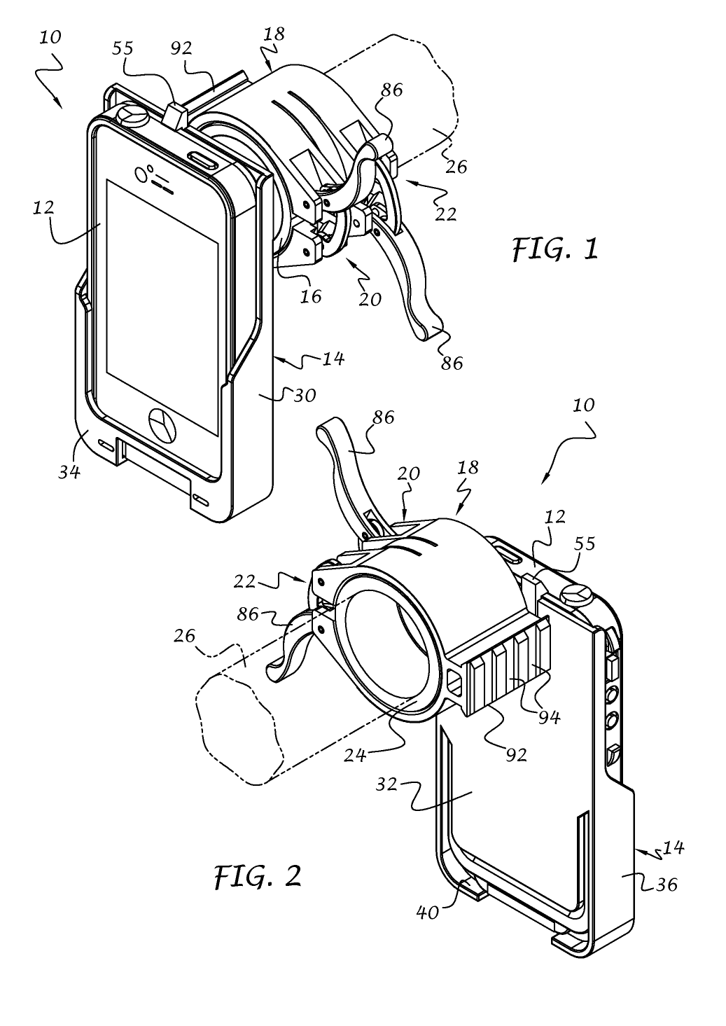

Referring to the drawings, and to FIGS. 1 and 2 in particular, an image modifying assembly 10 for a smart device, such as a smartphone 12, in accordance with an exemplary embodiment of the invention is illustrated. The image modifying assembly 10 is intended for use with any smart device that has a digital camera or the like for recording, viewing, and/or transmitting still images and/or video images over various data transfer protocols, such as Wi-Fi, wireless phone networks, and so on. Although the present invention will be described in conjunction with the smartphone 12, it will be understood that the invention is not limited thereto but may also be adapted to any device with image capturing and/or recording capabilities, such as smart pads, laptop computers, desktop computers, personal data assistants, cameras with fixed lenses or lens systems, and so on.

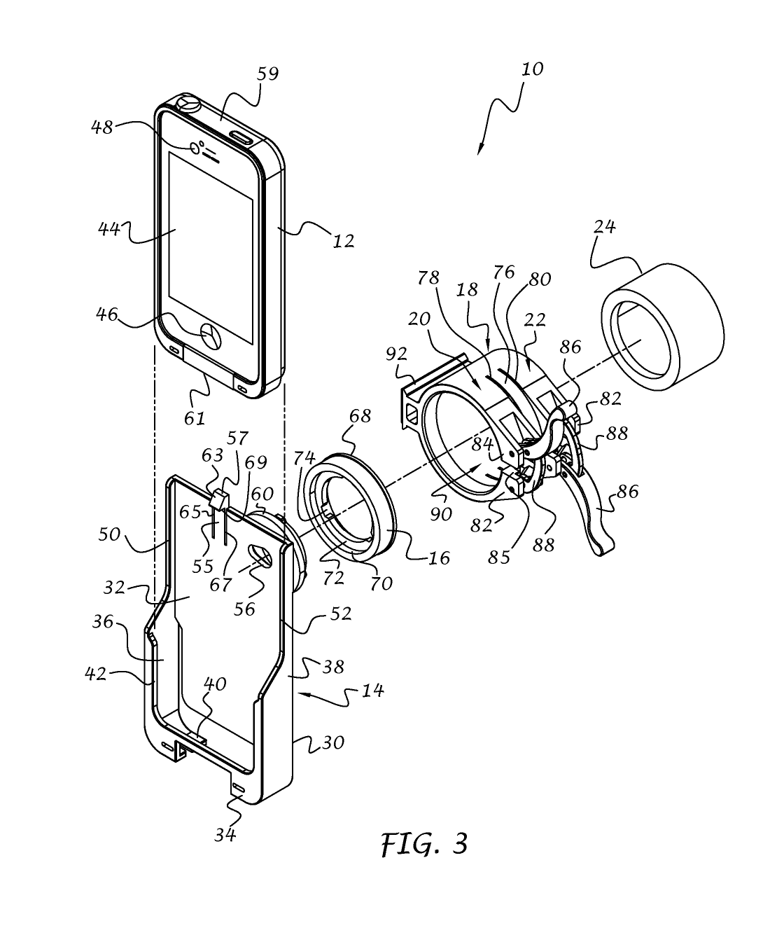

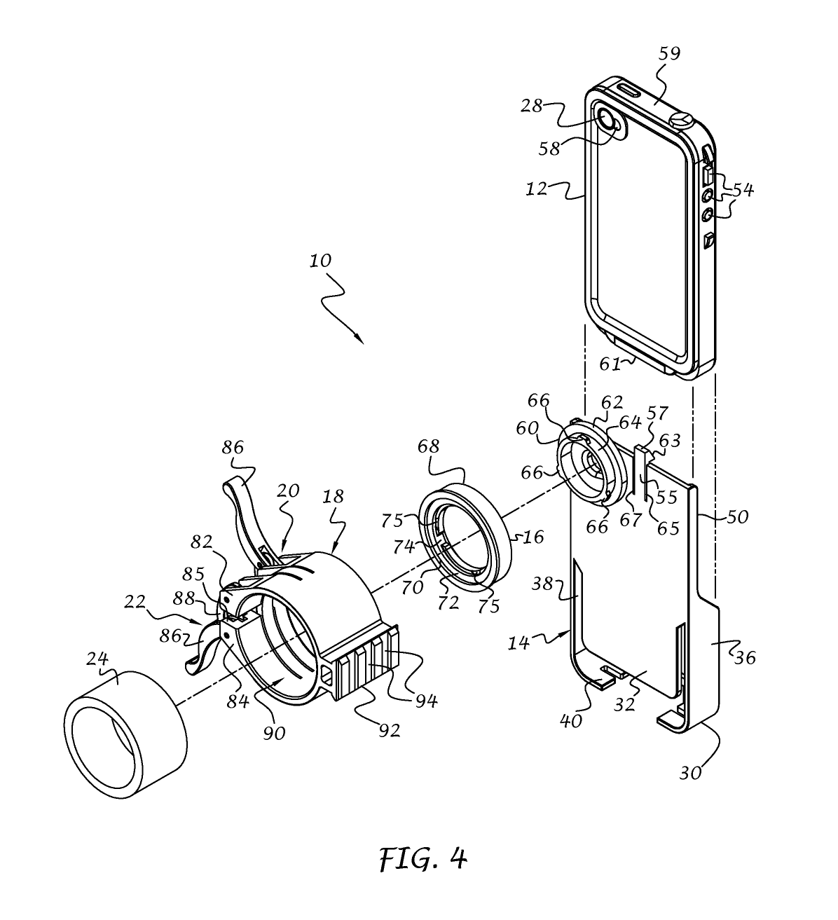

With additional reference to FIGS. 3 and 4, and in accordance with one exemplary embodiment of the invention, the image modifying assembly 10 preferably includes an adapter case 14 for receiving a smartphone 12, such as an iPhone™, Android™ phone, or the like, a locking collar 16 for connection to the adapter case 14, a clamping device 18 having a first clamping portion 20 for connection to the locking ring and a second clamping portion 22 for connection to an adapter bushing 24. The bushing 24 is in turn adapted to receive an image modifying device 26 (shown in phantom line in FIGS. 1 and 2). The image modifying device 26 can be any type of device and/or combination of devices that changes or modifies the image as it would otherwise be captured by the built-in rearwardly facing camera 28 (FIG. 4) of the smartphone 12 or other smart device.

The term “image modifying device” as used herein refers to any device, combination of devices and/or assembly that alters an image as perceived by the naked eye, e.g. that changes the apparent brightness, intensity, magnification, color, and/or field of view of an image, and/or that modifies an image through recording, transmitting, encoding, and so on. Such image modifying devices may include, but are not limited to, filters, one or more lenses, rifle or gun scopes, spotting scopes, telescopes, binoculars, laser rangefinders, mortar sights, anti-tank sights, bow sights, surveying transits, night vision monoculars or binoculars including image intensifying and thermal imaging devices, infrared cameras, image pickup devices, gyro-stabilized and digitally stabilized optics, film-type cameras, devices that transform an image into electrical signals such as still or video cameras of the digital or analog type, image recording devices, image pick-up heads, flying spot scanners, and so on.

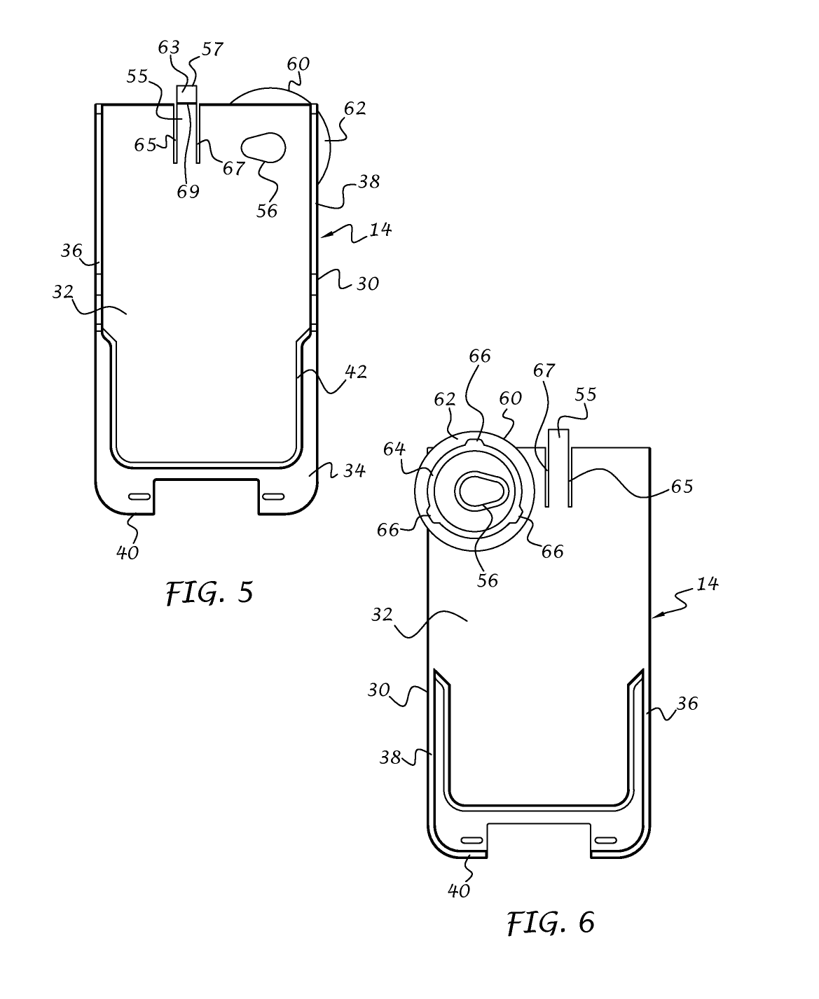

With additional reference to FIGS. 5 and 6, the adapter case 14 preferably includes a housing 30 with a rear wall 32, a front wall 34, a left side wall 36 (as viewed in FIG. 5) and a right side wall 38 extending between the rear and front walls, and a bottom wall 40 extending between the side walls and the rear and frond walls. An opening 42 is preferably formed in the front wall 34 for accommodating various features of the smartphone 12 (FIG. 3), including a display screen 44, a microphone 46, and a forward facing camera 48. Likewise, the side walls 36 and 38 preferably have respective openings 50 and 52 for accommodating various user interface components 54 (FIG. 4), such as control buttons, data ports, headphone jacks, power jacks, and so on, of the smartphone 12.

The rear wall 32 preferably includes an aperture 56 in alignment with the rearwardly facing camera 28 (FIG. 4). The aperture 56 is shown as oblong in shape to accommodate the camera lens as well as the camera flash component 58. However, it will be understood that the aperture 56 can be of any suitable shape to accommodate different camera and/or flash configurations. An integral spring-loaded clip 55 is formed in the rear wall 32 via a pair of slots 65, 67 that extend through the rear wall for retaining the smartphone 12 in the housing 30 during use. The clip preferably includes a locking projection 57 that extends forwardly from the rear wall 32 for engaging the upper surface 59 of the smartphone 12. When the smartphone 12 is inserted into the adapter case 14, the lower surface 61 of the smartphone will engage a ramped surface 63 of the projection 57 (best shown in FIG. 3), thereby forcing the clip 55 rearwardly. When the smartphone 12 is seated properly in the adapter case 14, the clip will spring back to its normal position with a lower surface 69 of the projection resting on or over the top surface 59 of the smartphone to thereby securely hold the smartphone in the adapter case 14. Removal of the smartphone is accomplished by manually moving the clip rearward until the projection 57 clears the smartphone then pulling the smartphone in an upward direction out of the adapter housing. It will be understood that other means for releasably retaining the smartphone in the adapter housing can be used without departing from the spirit and scope of the invention.

A connector 60 is preferably integrally molded with the housing 30 and extends rearwardly from the rear wall 32 for engaging the locking collar 16. However, it will be understood that the connector 60 can be formed separately and attached to the housing 30 through well known connection means such as welding, fastening, press-fitting, adhesive bonding, and so on, without departing from the spirit and scope of the invention. As best shown in FIG. 6, the connector 60 preferably includes a circular base portion 62 and an annular connecting portion 64 that extends rearwardly from the base portion 62. The connecting portion 64 preferably includes locking tabs 66 that are equally spaced about the periphery of the connecting portion and extend radially outwardly for releasably engaging the locking collar 16 as will be described below. Although the opening 56 and connector 60 are shown at a particular location, it will be understood that the location can vary depending on the type of smartphone or other device utilized.

As best shown in FIGS. 3 and 4, the locking collar 6 preferably includes an annular body 68 with an inner surface 70 and an inner wall 72 that extends radially inwardly from the inner surface 70. Axially extending slots 74 are formed in the wall 72 for receiving the locking tabs 66 of the locking collar 16. Preferably, the axial slots 74 are equally spaced around the periphery of the inner wall 72 and are equal in number to the locking tabs 66. Although three tabs and corresponding axial slots are shown, it will be understood that more or less tabs and/or slots can be provided without departing from the spirit and scope of the invention.

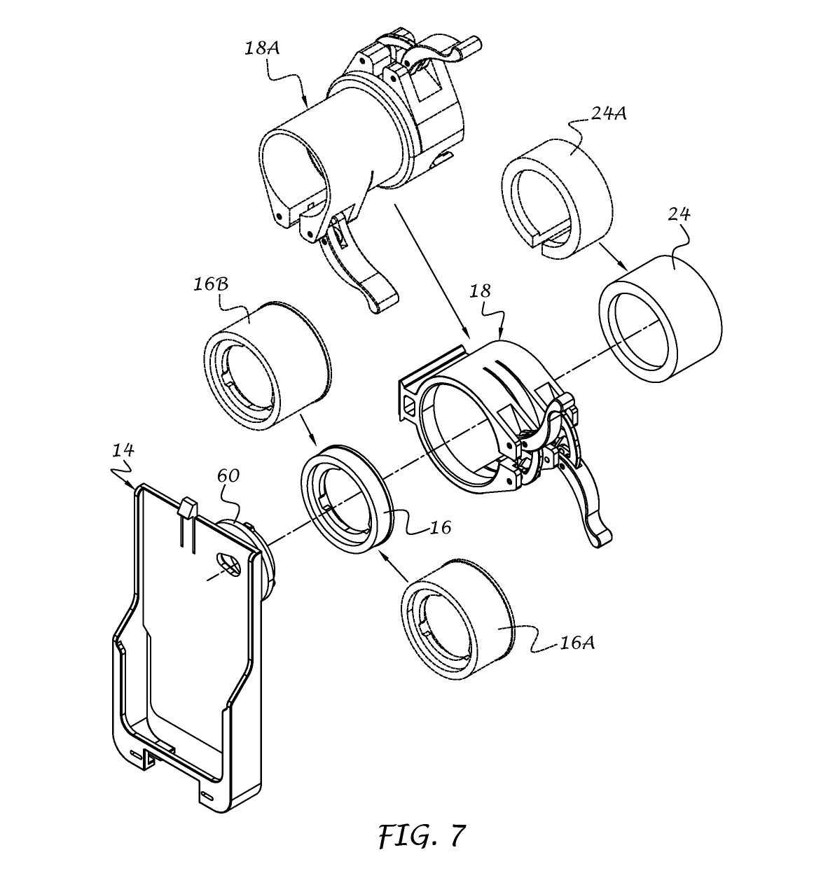

In order to connect the locking collar 6 to the adapter case 14, the axial slots 74 of the locking collar 6 are aligned with the locking tabs 66 of the connector 60. The collar is then moved axially toward the connector until the tabs 66 clear the slots. The collar is then rotated until the tabs 66 are no longer aligned with the slots and seated in locking depressions 75, which are shaped to complement the shape of the tabs 66, to thereby lockingly engage the collar 6 with the adapter case 14. Disconnection of the locking collar 6 from the adapter case 14 is performed in the reverse order. The quick connect/disconnect feature of the invention is advantageous in that different locking collars for different image modifying devices can be quickly changed out, as will be described in further detail with respect to FIG. 7.

With particular reference to FIGS. 3 and 4, the clamping device 18 preferably includes the first and second clamping portions 20, 22 are preferably substantially identical in construction, with the clamping portion 20 being a mirror image of the clamping portion 20. The clamping portions 20, 22 are separated by a sleeve portion 76. As shown, the sleeve portion 76 is of generally hollow cylindrical configuration and is partially separated from the clamping portions 20 and 22 by respective circumferentially extending slots 78 and 80 that extend through a thickness of the sleeve portion 76 from an outer surface to an inner surface thereof. Preferably, each slot 78, 80 extends approximately half-way around the circumference of the sleeve portion 76 to form arcuate clamping legs 82, 84 that move toward and away from each other. A space or gap 85 between the clamping legs 82, 84 accommodates relative leg movement between clamped and unclamped positions. A lever arm 86 is pivotally connected to the clamping leg 84. A link arm 88 is pivotally connected to the clamping leg 82 and the locking lever 86 to provide leverage when the lever arm is rotated toward a clamping position to thereby move the legs 82, 84 towards each other. A bore 90 extends through the clamping portions 20, 22 and sleeve portion 20 for receiving the locking collar 16 and the adapter bushing 24 and/or image modifying device 26 (FIG. 1). An accessory mounting bar 92 is preferably connected to the clamping device 18 and can include a plurality of parallel slots 94 (FIG. 4) for mounting various image modifying accessories, such as one or more of the devices previously as previously described, in a well-known manner, and/or for mounting the clamping device 18 to a tripod, firearm, or other movable or stationary base member (not shown).

In use, each lever arm 86 of the clamping device 18 is initially in an open position (FIGS. 3 and 4) prior to mounting the clamping device 18 to the locking collar 16 and an image modifying device 26 (FIG. 1). Depending on the type of image modifying device that will be coupled to the smartphone 12 or other device, an elastomeric adapter bushing 24 may be positioned in the bore 90 of the clamping portion 22 or mounted on the image modifying device prior to installing the image modifying device 26 in the clamping device 18. Once the image modifying device is received in the clamping portion 22, the locking lever 86 associated with the clamping portion 22 is rotated clockwise as viewed in FIG. 4. Rotation of the locking lever in this manner causes the link arm 88 to pull the legs 82 and 84 towards each other and reduce the size of the gap 85 and the diameter of the bore 90 until the lever arm 86 snaps toward an outer surface of the clamping portion 22. In this position, the legs 82, 84 are locked in a clamped or closed position to thereby firmly hold the image modifying device therein. The size of the reduced diameter and the bushing can be adjusted to accommodate a variety of different image modifying devices. Likewise, a similar procedure is followed for installing the locking collar in the clamping portion 20 of the clamping device 18. In order to release the adapter case 14 and/or the image modifying device 26 from the clamping portion 18, the reverse procedure is followed.

Further details of the clamping device 18 and its variations, as well as its method of operation, can be found in U.S. Pat. No. 6,449,419 issued to Brough et al. on Sep. 10, 2002, the disclosure of which is hereby incorporated by reference. In addition, it will be understood that the present invention can be used in combination with one or more of the clamping devices and systems disclosed in U.S. Pat. No. 6,449,419 to Brough et al.

It will be appreciated that the present invention enables the quick and easy configuration of many different optical viewing systems and devices using one or more of the clamp assemblies and/or image modifying devices without permanent modification to the various components. In particular, the clamping portions 20, 22 enable the relatively quick connection of the locking collar (and thus the adapter case 14) to an image modifying device 26 (FIG. 1) while ensuring optical alignment between the camera 28 of the smartphone 12 (or other device) and the image modifying device 26. In addition, the clamping device 18 also enables quick disconnection of the components. Thus, where it is desirous, for example, to couple a night vision monocular or a daylight scope to the smartphone 12 or other device, the clamping device 18 ensures that the monocular or other optical equipment will be optically aligned with and quickly connected to the camera 28.

Referring now to FIG. 7, an image modifying kit 100 in accordance with an exemplary embodiment of the invention is illustrated. The kit 100 preferably includes an adapter case 14 for receiving a smartphone or the like, a locking collar, such as locking collar 16, 16A, or 16B for connection to the adapter case 14, a clamping device, such as clamping device 18 or 18A, and an adapter bushing, such as bushing 24 or 24A. As shown, the locking collars 16, 16A and 16B are of different lengths and/or diameters to accommodate adapter cases and/or clamping devices of different sizes and/or configurations. Also, the clamping devices 18, 18A can be of different sizes and configurations as shown to accommodate a wide variety of image modifying devices. The adapter bushings 24, 24A can also be of different diameters, lengths, thicknesses, and so on, to accommodate different image modifying devices and clamping devices. In addition, one or more bushings of the kit 100 can be a spit bushing as shown at 24A to accommodate other image modifying devices. As described above, the image modifying devices can be any type of device that changes or modifies the image as it would otherwise be captured by the built-in rearwardly facing camera 28 (FIG. 4) of the smartphone 12 or other device having image capturing capabilities.

With the above-described exemplary embodiment of the invention, a universal system for connecting practically any image modifying device to a smart device without the necessity of purchasing redundant equipment specifically intended for only one application is provided. The live streaming of captured image data through well-known wireless networks in law enforcement and military applications where image modifying devices, such as lenses, rifle or gun scopes, spotting scopes, night vision monoculars, and so on, may have already been purchased, is advantageously enabled by the present invention.

It will be appreciated that terms of orientation and/or position as may be used throughout the specification, such as front, rear, lower, and upwardly, as well as their respective derivatives and equivalent terms, refer to relative, rather than absolute orientations and/or positions.

It will be appreciated by those skilled in the art that changes could be made to the embodiments described above without departing from the broad inventive concept thereof. By way of example, although a particular clamping structure has been shown and described for the front and rear clamping portions, it will be appreciated that other clamping arrangements can be used.

It will be understood, therefore, that this invention is not limited to the particular embodiments disclosed, but it is intended to cover modifications within the spirit and scope of the present invention as defined by the appended claims.

I claim:

1. An image modifying assembly for a smart device having an image capturing portion, the assembly comprising:
an adapter case for receiving the smart device, the adaptor case having a rear wall with an opening for alignment with the image capturing portion and a connector located on the wall;
a locking collar operably associated with the connector for removable attachment thereto; and
a clamping device having a first clamping portion for connection to the locking collar, a second clamping portion spaced from the first clamping portion, and a bore extending between the first and second clamping portions, the bore together with the locking collar and opening providing an optical path for the image capturing portion;
wherein the second clamping portion is adapted for connection to an image modifying device to thereby modify an image before it is received by the image capturing portion.

2. An image modifying assembly according to claim 1, and further comprising an image modifying device for connection to the second clamping portion, the image modifying device being selected from the group of filters, lenses, scopes, binoculars, laser rangefinders, gun sights, bow sights, surveying transits, night vision monoculars including image intensifying and thermal imaging devices, infrared cameras, and image pickup devices.

3. An image modifying assembly according to claim 1, wherein the connector comprises:
a circular base portion extending from the rear wall; and
a connecting portion extending from the base portion, the connecting portion having a plurality of tabs extending radially outwardly for engagement with the locking collar.

4. An image modifying assembly according to claim 3, wherein the locking collar comprises:
an annular body with an inner surface;
an inner wall extending radially inwardly from the inner surface; and
a plurality of slots extending axially through the inner wall, the slots being sized to receive the tabs;
wherein axial movement of the locking collar toward the connecting portion causes the tabs to pass through the slots and rotational movement of the locking collar causes misalignment of the tabs with respect to the slots to thereby releasably connect the locking collar to the connector.

5. An image modifying assembly according to claim 4, wherein the clamping device comprises:
a hollow sleeve connected between the first and second clamping portions;
each of the first and second clamping portions having a pair of first and second clamping legs for receiving the locking collar and image modifying device, each pair of clamping legs being separated from the sleeve by a slot that extends at least part way around a perimeter of the sleeve to thereby permit movement of the clamping legs toward and away from each other;
wherein movement of the clamping legs toward each other reduces a gap therebetween f to thereby clamp one of the locking collar and image modifying device therein, and wherein movement of the clamping legs away from each other increases the gap to thereby release the locking collar and the image modifying device.

6. An image modifying assembly according to claim 5, wherein at least one of the clamping portions further comprises:
a locking lever pivotally connected to one of the clamping legs; and
a link arm having a first end pivotally connected to the other clamping leg and a second end pivotally connected to the locking lever;
wherein rotation of the locking lever in one direction causes the clamping legs to move toward each other and rotation of the locking lever in an opposite direction causes the clamping legs to move away from each other.

7. An image modifying assembly according to claim 1, wherein the clamping device comprises:
a hollow sleeve connected between the first and second clamping portions;
each of the first and second clamping portions having a pair of first and second clamping legs for receiving the locking collar and image modifying device, each pair of clamping legs being separated from the sleeve by a slot that extends at least part way around a perimeter of the sleeve to thereby permit movement of the clamping legs toward and away from each other;
wherein movement of the clamping legs toward each other reduces a gap therebetween f to thereby clamp one of the locking collar and image modifying device therein, and wherein movement of the clamping legs away from each other increases the gap to thereby release the locking collar and the image modifying device.

8. An image modifying assembly according to claim 7, wherein at least one of the clamping portions further comprises:
a locking lever pivotally connected to one of the clamping legs; and
a link arm having a first end pivotally connected to the other clamping leg and a second end pivotally connected to the locking lever;
wherein rotation of the locking lever in one direction causes the clamping legs to move toward each other and rotation of the locking lever in an opposite direction causes the clamping legs to move away from each other.

9. An image modifying assembly according to claim 1, wherein the adapter case further comprises:
a housing including the a rear wall, a front wall, left and right side walls extending between the rear and front walls, and a bottom wall extending between the side walls and the rear and frond walls;
an opening formed in the front wall and side walls for accommodating user interface features of the smart device;
an integral spring-loaded clip formed in the rear wall for retaining the smart device in the housing during use, the clip including a locking projection that extends forwardly from the rear wall and having a lower surface for engaging an upper surface of the smart device and a ramped surface for engaging a lower surface of the smart device to push the projection rearwardly during insertion of the smart device into the housing, wherein the locking projection springs back to a locked position over the top surface of the smart device to thereby securely hold the smart device in the adapter case.

10. An image modifying assembly according to claim 9, wherein the connector is integrally formed with the adapter case.

11. An image modifying assembly according to claim 9, wherein the connector is formed separately of the adapter case and connected thereto.

12. An image modifying assembly according to claim 1, wherein the connector is integrally formed with the adapter case.

13. An image modifying assembly according to claim 1, wherein the connector is formed separately of the adapter case and connected thereto.

14. An image modifying assembly according to claim 1, wherein the connector is in optical alignment with the opening.

15. An image modifying assembly according to claim 1, and further comprising a resilient bushing received in the second clamping portion, the bushing being adapted to receive the image modifying device.

16. An image modifying kit for a smart device having an image capturing portion, the kit comprising:
an adapter case for receiving the smart device, the adaptor case having a rear wall with an opening for alignment with the image capturing portion and a connector located on the wall in alignment with the opening;
a plurality of locking collars operably associated with the connector for removable attachment thereto, each locking collar being of a different size;
a clamping device having a first clamping portion for connection to the locking collar, a second clamping portion spaced from the first clamping portion, and a bore extending between the first and second clamping portions, the bore together with the locking collar and opening providing an optical path for the image capturing portion; and
a plurality of resilient bushings adapted to be received in the second clamping portion, each bushing being of a different size for receiving different image modifying devices;
wherein the second clamping portion is adapted to clamp and hold a selected one of the resilient bushings with an image modifying device to thereby modify an image before it is received by the image capturing portion.

17. An image modifying assembly according to claim 16, and further comprising an image modifying device for connection to the second clamping portion, the image modifying device being selected from the group of filters, lenses, scopes, binoculars, laser rangefinders, gun sights, bow sights, surveying transits, night vision monoculars including image intensifying and thermal imaging devices, infrared cameras, and image pickup devices.

18. An image modifying assembly according to claim 16, wherein the connector comprises:
a circular base portion extending from the rear wall; and
a connecting portion extending from the base portion, the connecting portion having a plurality of tabs extending radially outwardly for engagement with the locking collar.

19. An image modifying kit according to claim 18, wherein each locking collar comprises:
an annular body with an inner surface;
an inner wall extending radially inwardly from the inner surface; and
a plurality of slots extending axially through the inner wall, the slots being sized to receive the tabs;
wherein axial movement of the locking collar toward the connecting portion causes the tabs to pass through the slots and rotational movement of the locking collar causes misalignment of the tabs with respect to the slots to thereby releasably connect the locking collar to the connector.

20. An image modifying assembly according to claim 19, wherein the adapter case further comprises:
a housing including the a rear wall, a front wall, left and right side walls extending between the rear and front walls, and a bottom wall extending between the side walls and the rear and frond walls;
an opening formed in the front wall and side walls for accommodating user interface features of the smart device;
an integral spring-loaded clip formed in the rear wall for retaining the smart device in the housing during use, the clip including a locking projection that extends forwardly from the rear wall and having a lower surface for engaging an upper surface of the smart device and a ramped surface for engaging a lower surface of the smart device to push the projection rearwardly during insertion of the smart device into the housing, wherein the locking projection springs back to a locked position over the top surface of the smart device to thereby securely hold the smart device in the adapter case.
